(19) United States
(12) Patent Application Publication
(10) Pub. No.: US 2005/0226983 A1
(43) Pub. Date: Oct. 13, 2005

(54) Method of preparing sweetener agglomerates and agglomerates prepared by the method

(76) Inventors: Abraham Bakal, Margate, NJ (US); Margaret Snyder, Flemington, NJ (US); Penny Cash, Denville, NJ (US); Anthony Fierro, Totowa, NJ (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/823,339

(22) Filed: Apr. 13, 2004

(51) Int. Cl. A23L 1/236

(52) U.S. Cl. 426/548

(57) ABSTRACT

A sweetener is provided which is an agglomerate of an intense sweetener and a carrier such the sweetener has a bulk density from 0.18 to 0.50 g./cc. The sweetener fills a readily recognizable package while using a smaller amount of carrier and having the same amount of sweetness. The sweetener is less hygroscopic than if the intense sweetener and carrier were merely mixed. The sweetener does not cake together. The sweetener may contain, for example, 35 parts of soluble aspartame, 40 parts of maltodextrin having 10 Dextrose Equivalent (DE), and 925 parts of dextrose, where the aspartame, maltodextrin and dextrose are agglomerated. The agglomeration technique may be to introduce the ingredients and spray water to control the particle size to affect uniform free flowing powder. The agglomeration technique may also be a conveyor type steam agglomerator.

### FIELD OF THE INVENTION

The present invention relates to powder sweeteners, methods for making powder the composition and manufacturing process for producing powdered sweeteners, and tabletop sweetener products comprising powder sweeteners packaged in a conventional packet.

### BACKGROUND OF THE INVENTION

Sweeteners may be used for sweetening a variety of products, including drinks, foods, confectioneries, pastries, chewing gums, hygiene products and toiletries, as well as cosmetic, pharmaceutical and veterinary products. Dry powder mixtures and blends of intense sweeteners with other agents are commonly referred to as powder sweeteners or tabletop sweeteners.

The usefulness of powder sweeteners depends on a number of characteristics. Good flow behavior is desired for processing and ease of handling. The ability to mix well and remain mixed with other ingredients is important for maintaining particle homogeneity of the powder mixture. A quick dissolution rate is important for tabletop and powder soft drink applications. Dusting of the product has to be minimal or entirely eliminated to avoid loss of product. Also, the product must fit into readily usable packaging which is accepted by the public.

Powder mixtures containing aspartame, saccharin, sucralose, acesulfame-k and other intense sweeteners are created by mixing the intense sweeteners with other sweeteners, carriers, bulking agents or fillers in products such as tabletop sweeteners, powdered soft drinks, chewing gums, and instant dessert products. For example, some of the carriers may be maltodextrin with dextrose, maltodextrin, dextrose, lactose, corn syrup solids or similar diluents.

Using small amounts of intense sweetener mixed with a granulated bulking agent or carrier presents several difficulties. Because of the extremely small amount of intense sweetener and a relatively large amount of a bulking agent or carrier used, the products may exhibit poor content uniformity. Because of the relatively small size of the particles of the intense sweetener as compared to bulking agent or carrier, these sweetener powders also may exhibit a high degree of segregation and dusting. The dusting is caused by the independent small particles of intense sweetener segregating from the larger, and therefore less prone to dusting, carrier. Moreover, the content uniformity and segregation problems associated with these often worsen during handling prior to packaging and in the case of bulk products, during shipping and also during periods of storage.

It has become conventional for powder sweetener to be provided in small packets of the type commonly seen on restaurant tables. The conventional packet is 2.5 in. by 1.5 in. For example, powdered sweeteners such as Sweet 'N Low®, Equal®, and Splenda® are packaged in such conventional packets. Sweet 'N Low® is a mixture of nutritive dextrose, 3.6% saccharin, cream of tartar and calcium silicate. Dextrose is a natural carbohydrate derived from corn and is used to dilute the intense sweetener saccharin to make it measurable for consumers. Since only a very small amount of intense sweetener provides the sweetness of two teaspoons of sugar, e.g., 0.036 grams of saccharin, a relatively large amount of bulking agent is added. The carrier provides a certain fill to the packet. Thus, conventional packets of sweetener contain one gram of sweetener comprised of, for example a mixture of 0.036 grams of saccharin and 0.964 grams of carrier or bulking agent. The carrier or bulking agent is comprised of, for example, 0.10 grams of maltodextrin and 0.864 grams of dextrose. This relatively large amount of carrier or bulking agent is necessary so that there is substantial volume to the sweetener powder mixture and a substantial fill of the packets.

A large amount of carrier or bulking agent increases the cost and the calorie content of the sweetener product and while reducing the quantity of the bulking agent (while maintaining the amount of the intense sweetener) in the powder mixture will not affect the sweetness of the mixture, the volume of the sweetener mixture will decrease, and the fill of the packet will diminish. As a result, the general public may mistakenly believe that less sweetener product with less sweetening is being provided. Therefore, reducing the amount of carrier or bulking agent without impacting the sweetness but while maintaining the “fill” of the packet, is desirable to reduce cost and caloric content. For example, a conventional sweetener packet containing only 0.5 grams of sweetener mixture instead of 1.0 gram of sweetener mixture, but still containing the same amount of intense sweetener and occupying the same volume to produce the same “fill” of a conventional packet is highly desirable.

Sweetening products are known which comprise agglomerates of intense sweeteners and bulking agents. Methods of agglomerating are well known. For example, fluidized bed agglomeration is well known in the art. The process is described in U.S. Pat. Nos. 2,856,290, 3,251,695, and 3,433,644. Typically, in both continuous and batch fluid bed agglomeration processes, finely divided particles are sprayed onto a fluidized bed of particles under moisture and temperature conditions which promote formation of an agglomerate. Often the process involves heating at least one of the components of the agglomerate to a temperature above its melting point.

U.S. Pat. No. 4,554,167 discloses a method for preparing agglomerates of aspartame and acid-containing food mixes. The aspartame is blended at an elevated temperature and the blending period is adjusted to produce a desired agglomerate size.

U.S. Pat. No. 3,761,288 discloses a co-drying technique for making a dipeptide sweetening compound with a bulk density as low as 0.04 g/cc.

U.S. Pat. Nos. 3,011,897 and 3,795,746 describe processes for the production of high intensity sweetener compositions in which powdered sucrose is agglomerated in association with the high intensity sweetener. Bulk densities as low as 0.3 g/cc. are described.

In the past, low density sweetener compositions have comprised a high intensity sweetener formulated with a low-density carrier so that the product provides the same degree of sweetness on a volume basis as sucrose, but with a reduced caloric value. Ordinary granulated sucrose has a poured bulk density of about 0.84 g/cc. The carrier, assuming it has a similar caloric content as sucrose, must accordingly have a lower bulk density, so that the caloric content can be reduced. For example, a maltodextrin product is described in U.S. Pat. No. 3,320,074 having a bulk density of 0.08 to 0.15 g./cc.

A number of processes for spray drying sucrose have been described, for example in British Patent 1,240,691, U.S. Pat. No. 3,674,557 and U.S. Pat. No. 3,615,723. The process of British Patent 1,240,691 provides powdered crystalline sucrose as a seed substance at the head of the spray drying tower. Spray dried combinations of high intensity sweeteners and sugars are known, for example a high intensity sweetener/dextrose combination is described in U.S. Pat. No. 3,930,048 having a bulk density of 0.4 g./cc.

U.S. Pat. No. 3,320,074 describes a different technique for expanding a carbohydrate using carbon dioxide to reduce bulk density. Hollow spheres are formed by injecting pressurized carbon dioxide into the maltodextrin syrup being sprayed. Similarly, U.S. Pat. No. 3,746,554 discloses a carbon dioxide-blown lactose product, again consisting of hollow spheres, with an overall bulk density of 0.2 g/cc. A further example of this type of product is disclosed in U.S. Pat. No. 4,303,684 in which a combination of fructose, and dextrins with sucrose are spray dried with pressurized carbon dioxide addition to give a low bulk density.

Bulk density is affected by the size of the agglomerate, and mixtures of larger agglomerates generally have a lower bulk density than mixtures of smaller agglomerates. U.S. Pat. No. 5,061,320, alters the ratio of hollow spheres of microcrystalline sucrose to crystals of sucrose to selectively adjust the bulk density of the sweetener product as required. Indeed, with the inclusion of high intensity sweetener a range of products can be obtained in which bulk densities in the range 0.77 to 0.15 g/cc. A high intensity sweetener is described which is agglomerated such that the powdered sweetener has a bulk density of between 0.77 g/cc. and 0.25 g/cc.

### SUMMARY OF THE INVENTION

Accordingly, it is an object of the present invention is to provide a new and improved sweetener having the same sweetness as contained in sweetener mixtures contained in conventional 1 gram packets and to provide a sweetener with a lower bulk density so as to require less bulking agent and still provide the same fill perception for standard sweetener packets.

In order to achieve this object and others, a sweetener comprising an intense sweetener agglomerated with a carrier is provided. The agglomerated sweetener provides the same perceived “fill,” the same sweetness with a reduced amount of bulking agent. The bulk density achieved by the agglomeration of the intense sweetener and the carrier is from 0.18 to 0.50 g./cc.

The sweetener is an agglomerate of an intense sweetener and a carrier such the sweetener has a bulk density from 0.18 to 0.50 g./cc. The sweetener fills a readily recognizable package while using a smaller amount of carrier and having the same amount of sweetness.

The sweetener is less hygroscopic than if the intense sweetener and carrier were merely mixed. The sweetener does not cake. The sweetener may contain, for example, 35 parts of soluble aspartame, 40 parts of maltodextrin having 10 Dextrose Equivalent (DE), and 925 parts of dextrose, where the aspartame, maltodextrin and dextrose are agglomerated. The agglomeration technique may be to introduce the ingredients and spray water to control the particle size to affect uniform free flowing powder. The agglomeration technique may also be a conveyor type steam agglomerator.

### DETAILED DESCRIPTION OF THE INVENTION

The present invention is a table top sweetening product for packing in packets using standard filling equipment. These powdered sweetening products consist of a high intensity sweetener and a bulk carrier agglomerated or co-dried to a controlled bulk carrier so that the bulk density of the powder is approximately 0.2 g./cc. or in a range of 0.18-0.35 g./cc. The agglomeration process adds controlled amounts of water to the mixture of the high intensity sweetener and bulk carrier. The water is then evaporated. This process will yield larger particles.

For a bulk density of approximately 0.2 g./cc., the concentration of various intense sweetener sweeteners which may be used, for example, would be as follows:
Saccharin: between 5% and 10% and preferably between 6% and 8%,
Aspartame: between 6% and 12% and preferably between % and 10%,
Sucralose: between 2% and 4% and preferably between 2% and 2.5%,
Acesulfame-K: between 6% and 12% and preferably between 9% and 11%.

Carriers in the form of dextrose, corn syrup solids, 30 DE or less maltodextrin or a combination of these can be used with the possible inclusion of additives such as gum arabic, xanthtn, etc.

This agglomeration will be less hydroscopic and more uniform in sweetness than if the high intensity sweetener and the bulk carrier were merely mixed together. The bulk density would be, for example, approximately 0.2 g/cc. The traditional bulk density of tabletop sweetener mixtures is 0.5 g/cc. Therefore, the powder will be packed in traditional sized packets for storage and distribution at significantly lower amount than the current 1 gram while occupying about the same volume. The sweetness per packet will be the same as the current packet; i.e. each tabletop sweetener packet will be approximately as sweet as two teaspoons of sugar. The powder is uniform in sweetness (no separation between the sweetener and carrier will occur during handling) and is less hygroscopic than a mixture of carrier and sweetener.

In one embodiment, the sweetener is made by mixing 3.5% soluble aspartame, 40% of maltodextrin having 10 Dextrose Equivalent (DE) and 92.5% of dextrose agglomerated by adding controlled amounts of water to the mixture and evaporating the water. The finished agglomerated powder would have a moisture content of about 5% and the particle size would indicate that over 60% were retained on US screen 80 mesh. The bulk density of the powder is approximately 0.47 g/cc. This powder would be uniform in composition and would not exhibit any separation between the intense sweetener and carrier. The finished product would show only about 1-2% variability in sweetness and would show no caking.

In another embodiment of the invention, a mixture of 720 parts of soluble saccharin and 9280 parts of 10 DE maltodextrin is mixed with 10,000 parts of water to form a uniform solution. This 50% solids mixture is then spray dried using a typical spray drier tower equipped with agglomerating system. The spray drier used is equipped to inject carbon dioxide prior to the drying nozzle. The powder leaving the tower after drying has a bulk density of approximately 0.28 g/cc. This product is uniform in sweetness and exhibits very low hygroscopic characteristics.

The sweetener is easily handled by packing equipment. This powder can be handled in the plant for packing without concern about particle size classification and sweetness uniformity. The product is packed using typical packet forming machines each packet containing 0.5 g, 36 mg of soluble saccharin and less than 2 calories. The powder in these packets occupies substantially the same volume as the 1 g in the packets using conventional sweeteners. The savings in carrier shown in this example is about 50% by weight.

In this invention, the carrier will play an important role in the finished properties and cost of the finished product. Some carriers are dextrose, dextrose with 10 DE maltodextrin with maltodextrin in the range of 5% to 20% of the total mix and preferably between 7% and 12% corn syrup solids with and without 10 DE maltodextrin in the same ratio, higher DE maltodextrin such as 28 DE maltodextrin, corn syrup solids with small amounts of gums such as gum Arabic, carrageenan, locust bean gum, xanthan gum with the gum not exceeding a concentration of 1% of the total weight of the powder.

There are many techniques for agglomerating. The following are three techniques that may be used with the invention.

Fluidized Bed Agglomeration: In this system the moisture is added in the form of a mist or spray so that the amount of water at any one time does not exceed 5% by weight of the total amount of powder in the agglomerating chamber. The air temperature can be varied between 220 and 300 F depending on the sensitivity of the material to exposure to high temperatures. It is understood that the higher the air temperature the faster is the evaporation time and the shorter is the time to agglomerate the product. This system is considered a batch system. The finished product will consist of an agglomerated powder with a bulk density in the range of 0.4-0.6 g./cc. and preferably in the range of 0.46 g./cc.-0.55 g./cc.

Continuous System Agglomeration: Another possible and widely used agglomeration technique is the use of a continuous system in which the powder is placed on a conveyor belt surrounded by a closed chamber. Moisture, typically in the form of saturated steam is introduced in the first section of the belt. The powder picks up this moisture. The powder is being tumbled and agitated, as it is moving through the chamber on the conveyor belt. The moisture gained is released as the powder is dried by a flow of air. The finished product will consist of an agglomerated powder with a bulk density in the range of 0.4 g./cc.-0.6 g./cc. and preferably in the range of 0.46 g./cc.-0.55 g./cc.

An Alternate Continuous System Agglomeration: It is possible to agglomerate the powder using a spray drier chamber. This technique may be considered as a combination of the fluidized bed and the conveyor belt system. The powder is introduced into the chamber from the top of the tower and it encounters moist air as it descends through the drier chamber. The air may contain sufficient moisture to raise the moisture content of the powder by about 5% by weight. The moisture is then lost as the powder is separated from the air in the cyclone.

The following examples illustrate but do not limit the invention:

### EXAMPLE 1

### Conventional

A conventional tabletop sweetener is made by mixing 36 g of soluble saccharin, 100 g of maltodextrin having 10 Dextrose Equivalent (DE) and 864 g of dextrose. This powder is mixed using typical mixing equipment known to those familiar with the art. Typically mixing is achieved using ribbon mixers, Sigma mixers, barrel mixers and others. Ribbon mixers are the most widely used mixers in the industry. Continuous ribbon mixers are also used in many establishments.

The bulk density of this mixed powder is 0.66 g/cc. The mixed powder is conveyed to hoppers feeding the packet forming and packing equipment. Several methods are used for conveying the powder to the hoppers. Some establishments use manual methods in which the powder is collected from the mixers in drums and the drums are then transported to the hoppers and the hoppers are filled manually. Other methods employ screw type conveyors or pneumatic conveyors to transfer the mixed powder to the hoppers. During this transfer, particle classification occurs and the sweetness of the powder is not uniform. The packets formed in the machine, weighing one gram vary in the concentration of the sweetener. The product described in this example was prepared using screw type conveyor to transfer the powder to the hoppers.

The variability in sweetener concentration was determined to be as high as 20%. Thus some packets contained as low as 28 mg of saccharin and others contained as high as 43 mg of saccharin. The target saccharin concentration is 36 mg per packet. Typical production of this product shows that the variability in concentration of the sweetener is about 10% of the target value ranging between 32.4 and 39.6 mg per one-gram packet.

These packets were stored at 80° F. and 70% relative humidity for several weeks. After three weeks of storage significant caking was observed.

### EXAMPLE 2

### Conventional

A conventional tabletop sweetener is made by mixing 36 g of soluble aspartame, 100 g of maltodextrin having 10 Dextrose Equivalent (DE) and 864 g of dextrose. This powder is mixed using typical mixing equipment known to those familiar with the art. Typically mixing is achieved using ribbon mixers, Sigma mixers, barrel mixers and others. Ribbon mixers are the most widely used mixers in the industry. Continuous ribbon mixers are also used in many establishments.

The bulk density of the mixed powder is 0.68 g/cc. The concentration of aspartame was also 36 mg per one-gram packet and the composition of the mix was the same as described in Example 1. The results of this packing showed that the sweetness of the finished packets showed a variability of between 5 and 10% from the target sweetener concentration. Some packets contained as much as 38 mg of aspartame and others contained as low as 33 mg of aspartame instead of the target concentration of 36 mg per one-gram packet.

In addition, as in the case of the product of Example 1, the product showed significant caking when stored at 80° F. and 70% relative humidity even after three weeks of storage.

### EXAMPLE 3

A tabletop sweetener is made by mixing 35 g of soluble aspartame, 40 g of maltodextrin having 10 Dextrose Equivalent (DE) and 925 g of dextrose using a ribbon mixer. This powder was agglomerated using a Glatt fluidized bed agglomerator. The agglomeration process involves the addition of controlled amounts of water to the powder and evaporating said water.

The finished agglomerated powder had a moisture content of about 5% and the particle size distribution indicated that over 60% were retained on US screen 80 mesh. The bulk density of the powder is about 0.47 g/cc. This powder is uniform in composition and does not exhibit any separation between sweetener and carrier. The finished product shows only about 1-2% variability in sweetness and after three weeks of storage at 80° F. and 70% relative humidity no caking was detected.

The product is not prone to caking and provides consistent product sweetness unaffected or only slightly affected by handling during packing.

### EXAMPLE 4

A tabletop sweetener is made by mixing 36 g of soluble aspartame, 40 g of maltodextrin having 10 Dextrose Equivalent (DE) and 925 g of dextrose using a ribbon mixer. This powder was agglomerated using a Glatt fluidized bed agglomerator. The agglomeration process involves the addition of controlled amounts of water to the powder and evaporating said water.

The finished agglomerated powder had a moisture content of about 5% and the particle size distribution indicated that over 60% were retained on US screen 80 mesh. The bulk density of the powder is about 0.47 g/cc. This powder is uniform in composition and does not exhibit any separation between sweetener and carrier. The finished product shows only about 1-2% variability in sweetness and after three weeks of storage at 80° F. and 70% relative humidity no caking was detected.

The product is not prone to caking and provides consistent product sweetness unaffected or only slightly affected by handling during packing.

The experiment described in Example 3 is repeated while the ratio of maltodextrin and dextrose is modified. The following compositions were prepared:
1. A mixture of 3.5% aspartame, 90.5% dextrose and 6% maltodextrin
2. A mixture of 3.5% aspartame, 88.5% dextrose and 8% maltodextrin
3. A mixture of 3.5% aspartame, 86.5% dextrose and 10% maltodextrin

These samples were similar to the samples described in Example 3 and had bulk densities of approximately 0.5 g/cc and residual moisture content of between 5% and 7%. The data suggest that the higher the amount of maltodextrin the higher the residual moisture content.

These samples were evaluated in the same manner as the sample described in Example 3. They were significantly less prone to particle separation and showed consistent sweetness uniformity. In addition, no caking was detected after three weeks storage at 80° F. and 70% relative humidity.

### EXAMPLE 5

A mixture of 3927.10 g of dextrose and 954 g of 10 DE maltodextrin was prepared using a ribbon mixer. In a tank 158.8 g of aspartame was solubilized in 1360 cc of water. The powder was introduced into the Glatt agglomerator and the total amount of solution was added gradually while the powder is being agglomerated as described in Example 3.

The finished product consisted of 3.5% aspartame, 86.5% dextrose and 10% maltodextrin. This finished product had a bulk density of 0.512 g/cc and residual moisture content of 6.2%. This product had a uniform granulation and exhibited no separation during handling and packing. The product was free flowing and showed no caking even after three weeks of storage at 80° F. and 70% relative humidity.

### EXAMPLE 6

A mixture of 700 g of aspartame, 1000 g of 10 DE maltodextrin and 8,300 g of dextrose was made using a ribbon mixer. This mixture was agglomerated using a continuous type agglomerator. The agglomerator used was similar to a spray drier chamber in which the powder was introduced and water was sprayed to control the particle size and to affect uniform free flowing powder. Alternately, the product can be agglomerated in a conveyor type steam agglomerator.

The finished product had a bulk density of 0.32 g/cc and a residual moisture content of 5%. This product is free flowing, exhibits low hygroscopic characteristics and when 0.5 g of this agglomerated powder is packed in typical packets it occupies substantially the same space as 1 g of the product described in Example 2. Both these packets and the packets of Example 2 contain 35 mg of aspartame although the packet of this example contains only 0.465 g of carrier.

### EXAMPLE 7

A mixture of 720 g of soluble saccharin, 1000 g of 10 DE maltodextrin and 8,280 corn syrup solids were mixed with 10,000 g of water to form a uniform solution. This 50% solids mixture is then spray dried using a typical spray drier tower equipped with agglomerating system. The powder leaving the tower after drying has a bulk density of 0.35 g/cc and is free flowing.

This product is uniform in sweetness and exhibits very low hygroscopic characteristics. This powder can be handled in the plant for packing without concern about particle size classification and sweetness uniformity. The product is packed using typical packet forming machines each packet containing 0.5 g, 36 mg of soluble saccharin and less than 2 calories. The powder in these packets occupies substantially the same volume as the 1 g in the packets described in Example 1. In comparison, the packets described in Example 1 also contain 36 mg of soluble saccharin but has slightly less than 4 calories per packet. The savings in carrier shown in this example is about 50% by weight.

### EXAMPLE 8

A mixture of 720 g of soluble saccharin, 1000 g of 10 DE maltodextrin and 8,280 g of dextrose was mixed with 10,000 g of water to form a uniform solution. This 50% solids mixture is then spray dried using a typical spray drier tower equipped with agglomerating system. The powder leaving the tower after drying has a bulk density of 0.35 g/cc and is free flowing.

This product is uniform in sweetness and exhibits very low hygroscopic characteristics. This powder can be handled in the plant for packing without concern about particle size classification and sweetness uniformity. The product is packed using typical packet forming machines each packet containing 0.5 g, 36 mg of soluble saccharin and less than 2 calories. The powder in these packets occupies substantially the same volume as the 1 g in the packets described in Example 1. In comparison, the packets described in Example 1 also contain 36 mg of soluble saccharin but has slightly less than 4 calories per packet. The savings in carrier shown in this example is about 50% by weight.

### EXAMPLE 9

A mixture of 720 g of soluble saccharin and 9280 g of 10 DE maltodextrin were mixed with 10,000 g of water to form a uniform solution. This 50% solids mixture is then spray dried using a typical spray drier tower equipped with agglomerating system. The spray drier used is equipped to inject carbon dioxide prior to the drying nozzle. The powder leaving the tower after drying has a bulk density of 0.28 g/cc and is free flowing. The product had uniform spherical particles easily handled by the packing equipment. This product is uniform in sweetness and exhibits very low hygroscopic characteristics. This powder can be handled in the plant for packing without concern about particle size classification and sweetness uniformity.

The product is packed using typical packet forming machines each packet containing 0.5 g, 36 mg of soluble saccharin and less than 2 calories. The powder in these packets occupies substantially the same volume as the 1 g in the packets described in Example 1. In comparison, the packets described in Example 1 also contain 36 mg of soluble saccharin but has slightly less than 4 calories per packet. The savings in carrier shown in this example is about 50% by weight.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A sweetener comprising an agglomerate of an intense sweetener and a carrier such that the sweetener has a bulk density from 0.18 to 0.50 g./cc.

2. A sweetener comprising an agglomerate of an intense sweetener and a carrier such that the sweetener has a bulk density from 0.18 to 0.35 g./cc.

3. A sweetener comprising an agglomerate of an intense sweetener and a carrier such that the sweetener has a bulk density from 0.20 to 0.30 g./cc.

4. The sweetener according to claim 1, wherein the sweetener fills a recognizable package while using a smaller amount of carrier and having the same amount of sweetness as a conventional sweetener having a bulk density of 0.66 g./cc.

5. The sweetener according to claim 4, wherein the sweetener is less hygroscopic than if the intense sweetener and carrier were merely mixed.

6. The sweetener according to claim 4, wherein the sweetener does not cake together.

7. A sweetener comprising:
35 parts of soluble aspartame;
40 parts of maltodextrin having 10 Dextrose Equivalent (DE); and
925 parts of dextrose, where the aspartame, maltodextrin and dextrose were agglomerated.

8. A sweetener comprising:
3.5 percent soluble aspartame;
6 percent of maltodextrin having 10 Dextrose Equivalent (DE); and
90.5 percent of dextrose, where the aspartame, maltodextrin and dextrose were agglomerated.

9. A sweetener comprising:
3.5 percent soluble aspartame;
8 percent maltodextrin having 10 Dextrose Equivalent (DE); and
88.5 percent dextrose, where the aspartame, maltodextrin and dextrose were agglomerated.

10. A sweetener comprising:
3.5 percent soluble aspartame;
10 percent maltodextrin having 10 Dextrose Equivalent (DE); and
86.5 percent dextrose, where the aspartame, maltodextrin and dextrose were agglomerated.

11. The sweetener of claim 7 wherein the bulk density of the sweetener is approximately 0.50 g/cc.

12. The sweetener of claim 7 wherein the residual moisture content of the sweetener is between 5% and 7%.

13. A sweetener comprising:
700 parts soluble aspartame;
1000 parts maltodextrin having 10 Dextrose Equivalent (DE); and
8300 parts dextrose, where the aspartame, maltodextrin and dextrose were agglomerated.

14. The sweetener of claim 13 wherein the bulk density of the sweetener is approximately 0.32 g/cc.

15. The sweetener of claim 13 wherein the agglomeration technique was a continuous type agglomeration technique.

16. The sweetener of claim 13 wherein the agglomeration technique was to introduce the ingredients and spray water to control the particle size to affect uniform free flowing sweetener.

17. The sweetener of claim 13 wherein the agglomeration technique was a conveyor type steam agglomeration technique.

18. The sweetener of claim 13 wherein the sweetener is free flowing.

19. The sweetener of claim 13 wherein the sweetener exhibits low hygroscopic characteristics.

20. The sweetener of claim 13 wherein when 0.5 g of the agglomerated sweetener is packed in typical packets, it occupies substantially the same space as 1 g of a conventional mixed sweetener having a bulk density of 0.66 g./cc.

21. A sweetener comprising:
720 parts soluble aspartame;
1000 parts maltodextrin having 10 Dextrose Equivalent (DE);
8280 parts dextrose; and
10,000 g of water mixed with the aspartame, maltodextrin and dextrose to form a uniform solution, where the mixture is agglomerated.

22. The sweetener of claim 21 wherein the mixture is agglomerated using a spray drier tower agglomerating system.

23. The sweetener of claim 21 wherein the bulk density of the sweetener is approximately 0.35 g/cc.

24. The sweetener of claim 21 wherein 0.5 g of the sweetener contains 36 mg of soluble aspartame.

25. The sweetener of claim 21 wherein the sweetener contains less than 2 calories.

26. A sweetener comprising:
720 parts soluble aspartame;
1000 parts maltodextrin having 10 Dextrose Equivalent (DE);
8280 parts corn syrup solids; and
10,000 g of water mixed with the Aspartame, maltodextrin and corn syrup solids to form a uniform solution, where the mixture is agglomerated.

27. The sweetener of claim 26 wherein the mixture is agglomerated using a spray drier tower agglomerating system.

28. The sweetener of claim 26 wherein the bulk density of the sweetener is approximately 0.35 g/cc.

29. The sweetener of claim 26 wherein 0.5 g of the sweetener contains 36 mg of soluble aspartame.

30. The sweetener of claim 26 wherein the sweetener contains less than 2 calories.

31. The sweetener of claim 26 wherein the spray drier used is equipped to inject carbon dioxide prior to a drying nozzle.

32. The sweetener of claim 26 wherein the sweetener has a bulk density of 0.28 g/cc.

33. The sweetener of claim 26 wherein the sweetener has uniform spherical particles.

34. The sweetener of claim 26 wherein the sweetener contains no bound crystals.

35. The sweetener of claim 1 wherein the high intensity sweetener comprises sucralose, saccharin, a dipeptide sweetener, acesulfame-K, cyclamate, stevioside or a combination of two or more thereof.

36. A method for preparing an sweetener comprising the steps of:
providing an intense sweetener; and
agglomerating the intense sweetener with a carrier such that the sweetener has a bulk density from 0.18 g./cc. to 0.50 g./cc.

37. A method for preparing an sweetener comprising the steps of:
providing an intense sweetener; and
agglomerating the intense sweetener with a carrier such that the sweetener has a bulk density from 0.18 g./cc. to 0.35 g./cc

38. A method for preparing an sweetener comprising the steps of:
providing an intense sweetener; and
agglomerating the intense sweetener with a carrier such that the sweetener has a bulk density from 0.20 g./cc. to 0.30 g./cc.

39. A method for preparing an sweetener comprising the steps of:
providing 35 parts of soluble aspartame;
providing 40 parts of maltodextrin having 10 Dextrose Equivalent (DE);
providing 925 parts of dextrose; and
agglomerating the aspartame, maltodextrin and dextrose.

40. The sweetener of claim 39 wherein the bulk density is approximately 0.50 g/cc.

41. The sweetener of claim 39 wherein the residual moisture content of the sweetener is between 5% and 7%.

42. A method for preparing an sweetener comprising the steps of:
providing 700 parts of soluble aspartame;
providing 1000 parts of maltodextrin having 10 Dextrose Equivalent (DE);
providing 8300 parts of dextrose; and
agglomerating the aspartame, maltodextrin and dextrose.

43. The sweetener of claim 42 wherein the bulk density of the sweetener is approximately 0.32 g/cc.

44. The sweetener of claim 42 wherein the agglomeration technique is a continuous type agglomeration technique.

45. The sweetener of claim 42 wherein the step of agglomerating further comprises the step of introducing the ingredients and spraying water to control the particle size to affect uniform free flowing powder.

46. The sweetener of claim 42 wherein the step of agglomerating uses a conveyor type steam agglomerator.

47. The sweetener of claim 42 wherein the sweetener is free flowing.

48. The sweetener of claim 42 wherein the sweetener exhibits low hygroscopic characteristics.

49. The sweetener of claim 42 wherein when 0.5 g of the agglomerated sweetener is packed in typical packets, it occupies substantially the same space as 1 g of a conventional sweetener product having a bulk density of 0.66 g./cc.

50. A method for preparing an sweetener comprising the steps of:
providing 720 parts of soluble aspartame;
providing 1,000 parts of maltodextrin having 10 Dextrose Equivalent (DE);
providing 10,000 parts of dextrose;
mixing 10,000 parts of water with the aspartame, maltodextrine and dextrose; and
agglomerating the mixture.

51. The sweetener of claim 50 wherein the step of agglomerating uses a spray drier tower agglomerating system.

52. The sweetener of claim 50 wherein the bulk density of the sweetener is approximately 0.35 g/cc.

53. The sweetener of claim 50 wherein 0.5 g of the sweetener contains 36 mg of soluble aspartame.

54. The sweetener of claim 50 wherein the sweetener contains less than 2 calories.

55. The sweetener of claim 50 wherein the step of agglomerating further comprises injecting carbon dioxide prior to a drying nozzle.

56. The sweetener of claim 50 wherein the sweetener has a bulk density of 0.28 g/cc.

57. The sweetener of claim 50 wherein the sweetener has uniform spherical particles.

58. The sweetener of claim 50 wherein the sweetener contains no bound crystals.

59. The sweetener of claim 36 wherein the high intensity sweetener comprises sucralose, saccharin, a dipeptide sweetener, acesulfame-K, cyclamate, stevioside or a combination of two or more thereof.

60. A tabletop sweetener comprising:
a sweetener including an agglomerate of an intense sweetener and a carrier such that the sweetener has a bulk density from 0.18 to 0.50 g./cc; and
a packet for containing said sweetener.

61. A sweetener comprising an agglomerate of an intense sweetener and a carrier such that the sweetener has a bulk density from 0.18 to 0.35 g./cc.

62. A sweetener comprising an agglomerate of an intense sweetener and a carrier such that the sweetener has a bulk density from 0.20 to 0.30 g./cc.

63. The tabletop sweetener of claim 60 wherein said packet is a conventional tabletop sweetener packet with dimensions of 1.5 inches by 2.5 inches.

64. The tabletop sweetener of claim 63 wherein said sweetener fills said packet to the same level while using a smaller amount of carrier and having the same amount of sweetness as a conventional sweetener having a bulk density of 0.66 g./cc.

65. The sweetener of claim 63 wherein when 0.5 g of the agglomerated sweetener occupies substantially the same space as 1 g of a conventional mixed sweetener product having a bulk density of 0.66 g./cc.

66. A method for preparing a tabletop sweetener comprising the steps of:
providing an intense sweetener;
agglomerating the intense sweetener with a carrier such that the sweetener has a bulk density from 0.18 g./cc. to 0.50 g./cc; and
placing the agglomeration in a packet.

67. A method for preparing a tabletop sweetener comprising the steps of:
providing an intense sweetener;
agglomerating the intense sweetener with a carrier such that the sweetener has a bulk density from 0.18 g./cc. to 0.35 g./cc; and
placing the agglomeration in a packet.

68. A method for preparing a tabletop sweetener comprising the steps of:
providing an intense sweetener;
agglomerating the intense sweetener with a carrier such that the sweetener has a bulk density from 0.20 g./cc. to 0.30 g./cc; and
placing the agglomeration in a packet.

69. The method of claim 66 wherein said packet is a conventional tabletop sweetener packet with dimensions of 1.5 inches by 2.5 inches.

70. The method of claim 69 wherein the step of placing the agglomeration in a packet comprises filling the packet to a recognizable level while using a smaller amount of carrier and having the same amount of sweetness as a conventional sweetener having a bulk density of 0.66 g./cc.

71. The method of claim 66 wherein 0.5 g of the agglomeration placed in the packet fills the packet to substantially the same volume as 1 g of a conventional mixed sweetener product having a bulk density of 0.66 g./cc.

72. A method for preparing a tabletop sweetener comprising the steps of:
providing 35 parts of soluble aspartame;
providing 40 parts of maltodextrin having 10 Dextrose Equivalent (DE);
providing 925 parts of dextrose;
agglomerating the aspartame, maltodextrin and dextrose; and
placing the agglomeration in a packet.

73. The sweetener of claim 72 wherein the bulk density is approximately 0.50 g/cc.

74. The sweetener of claim 72 wherein the residual moisture content of the sweetener is between 5% and 7%.
